(19) United States
(12) Patent Application Publication
(10) Pub. No.: US 2020/0058288 A1
(43) Pub. Date: Feb. 20, 2020

(54) TIMBRE-SELECTABLE HUMAN VOICE PLAYBACK SYSTEM, PLAYBACK METHOD THEREOF AND COMPUTER-READABLE RECORDING MEDIUM

(71) Applicant: National Taiwan University of Science and Technology, Taipei (TW)

(72) Inventors: Chyi-Yeu Lin, Taipei (TW); Hung-Yan Gu, Taipei (TW)

(73) Assignee: National Taiwan University of Science and Technology, Taipei (TW)

(21) Appl. No.: 16/377,258

(22) Filed: Apr. 8, 2019

(30) Foreign Application Priority Data
Aug. 16, 2018 (TW) 107128649

(51) Int. Cl. G10L 13/04; G06F 9/451; G06F 16/31

(52) U.S. Cl. CPC G10L 13/04; G06F 16/31; G06F 9/451

(57) ABSTRACT

A timbre-selectable human voice playback system and a timbre-selectable human voice playback method thereof are provided. The timbre-selectable human voice playback system includes a speaker, a storage and a processing apparatus. The storage saves a text database. The processing apparatus is connected to the speaker and the storage. The processing apparatus obtains real human voice signals, converts the text of the text database into original synthetic human voice signals with the text-to-speech technology, and transforms the original synthetic voice signals into timbre-specific human voice signals with a timbre transformation model. The timbre-transformation model is trained with the real human voice signals collected from a specific person. Then, the processing apparatus plays the transformed human voice signals with the speaker. Accordingly, a user can listen to his favorite voice timbre and the transformed voice signal carrying selected content anytime and anywhere.

### CROSS-REFERENCE TO RELATED APPLICATION

This application claims the priority benefit of Taiwan application serial no. 107128649, filed on Aug. 16, 2018. The entirety of the above-mentioned patent application is hereby incorporated by reference herein and made a part of this specification.

### BACKGROUND OF THE INVENTION

### Field of the Invention

The disclosure relates to an applied technique of human voice transformation, and more particularly, to a timbre-selectable human voice playback system, a method thereof and a computer readable recording medium.

### Description of Related Art

The voice of a particular person may resonate psychologically with some people. Therefore, many people hope that a specific person can tell a story to them. For example, children want their favorite persons, such as father, mother, or even grandfather or grandmother, to read a story book aloud (tell a story) to them. If the people, who are expected to read the story, stay with the children, they may be able to read the story to the children in person. However, in actual, even if these people stay with the children, they may not have time to tell the stories. Needless to say that, sometimes parents are not at home, and the grandparents may not live with the children. If so, it is even more difficult for these people to tell the children stories.

Although the prior art allows saving the voice of a specific person telling a story and playing back the saved voice, not everyone has sufficient free time to save all contents of five or more story books. In addition, although a specific text article can be converted into synthetic human voice through text-to-speech (TTS) technology, there is no related existing products that provides a friendly operation interface for the user to select the voice timbre of a specific person that the user intends to listen to.

### SUMMARY OF THE INVENTION

In light of the above, a timbre-selectable human voice playback system, a method thereof and a computer readable recording medium are provided. A voice timbre of a designated person that the user intends to listen to and a speech signal synthesized from a selected text are played. Therefore, the user can listen to the familiar voice timbre and speech signals anytime and anywhere.

The timbre-selectable human voice playback system includes a speaker, a storage and a processing apparatus. The speaker is adapted for playing a sound. The storage is adapted for saving human voice signals and a text database. The processing apparatus is connected to a voice input apparatus, the speaker and the storage. The processing apparatus obtains a real human voice signal, transforms a text content from the text database to an original synthetic human voice signal with a text-to-speech technology, and inputs the original synthetic human voice signal to a timbre transformation model for transforming the original synthetic human voice signal to a synthetic human voice signal of a specific timbre. Said timbre transformation model is trained with the human voice signals collected from a specific person. Then, the processing apparatus plays the transformed timbre-specific synthetic human voice signals with the speaker.

In an embodiment of the disclosure, the processing apparatus obtains acoustic features from the collected human voice signals, generates synthetic human voice signals with the text-to-speech technology according to the text scripts corresponding to the collected human voice signals, obtains acoustic features from the synthetic human voice signals, and trains the voice timbre transformation model with the parallel acoustic features of the two kinds of voice signals (of the real human voice signal and of the synthetic human voice signal).

In an embodiment of the disclosure, the processing apparatus provides a user interface presenting the source persons of the collected human voice signals and the titles of the article texts collected in the text database, receives commands to select one of the source persons and one of the articles collected in the text database on the user interface, and transforms a sequence of sentences of a selected article to synthetic human voice signals in response to said selection commands.

In an embodiment of the disclosure, said storage further saves the real human voice signals saved by multiple real persons at multiple recording times. The processing apparatus provides a user interface presenting the real persons and the recording times, and receives commands to select one of the real persons and one of the recording times on the user interface, and obtains a timbre transformation model corresponding to the selected real person and recording time in response to said selection commands.

In an embodiment of the disclosure, said human voice playback system further includes a display connected to the processing apparatus. The processing apparatus collects at least a real human face image, generates mouth shape-variation data according to the synthetic human voice signal, transforms one real human face image into a transformed human face image according to the mouth shape-variation data, and simultaneously displays the transformed human face image with the display and plays the synthetic human voice signal with the speaker.

In an embodiment of the disclosure, said human voice playback system further includes a mechanical head connected to the processing apparatus. The processing apparatus generates mouth shape-variation data according to the synthetic human voice signal, controls mouth movements of the mechanical head according to the mouth shape-variation data, and simultaneously plays the synthetic human voice signal with the speaker.

The human voice playback method of the disclosure includes the following. A real human voice signal is collected. Each sentence of an article text is transformed to an original synthetic human voice signal with a text-to-speech technology. The original synthetic human voice signal is input to a timbre transformation model for transforming the original synthetic human voice signal to a synthetic human voice signal of a specific timbre. The timbre transformation model is established by training it with paired human voice signals (real human voice signals and synthetic human voice signals). Then, the synthetic human voice signal that is transformed is played.

In an embodiment of the disclosure, before the original synthetic human voice signal is input to the timbre transformation model for transforming the original synthetic human voice signal to the synthetic human voice signal, the human voice playback method further includes the following steps. Acoustic features are analyzed from the collected real human voice signals, and synthetic human voice signals are generated with the text-to-speech technology according to the text scripts corresponding to the collected real human voice signals. Acoustic features are analyzed from the synthetic human voice signals. The timbre transformation model is trained with the acoustic features of the collected human voice signals and the acoustic features of the synthetic human voice signals.

In an embodiment of the disclosure, before the synthetic human voice signals are generated with the text-to-speech technology according to the text script corresponding to the collected real human voice signals, the method further includes the following steps. A user interface is provided, where the user interface presents the source persons of the collected real human voice signals and the titles of the scripts in the text database collected from the text scripts of the human voice signals. A command to select one of the source persons and one of the text scripts on the user interface is received. In response to the selection commands, each sentence in the text script selected is transformed to a synthetic human voice signal.

In an embodiment of the disclosure, said obtaining the timbre transformation model includes the following steps. The real human voice signals recorded by multiple real persons at multiple recording times are saved. A user interface presenting the real persons and the recording times is provided. Commands to select one of the real persons and one of the recording times on the user interface are received. In response to the selection commands, a timbre transformation model corresponding to a selected real human voice signal is trained.

In an embodiment of the disclosure, the content of the text collected in the text database relates to at least one of such text sources, mails, messages, books, advertisements and news.

In an embodiment of the disclosure, after transforming to the synthetic human voice signal, the method further includes the following. A real human face image is obtained. Mouth shape-variation data is generated according to the synthetic human voice signal. A real human face image is transformed into a transformed human face image according to said mouth shape-variation data. The transformed human face image is displayed simultaneously while the synthetic human voice signal is played.

In an embodiment of the disclosure, after transforming to the synthetic human voice signal, the method further includes the following steps. Mouth shape-variation data is generated according to the synthetic human voice signal. The mouth movements of the mechanical head are controlled according to the mouth shape-variation data, and the synthetic human voice signal is simultaneously played.

A storage apparatus saves a program code to be loaded by a processor of an apparatus for performing the following steps. A real human voice signal is collected. Each sentence of a text script is transformed to an original synthetic human voice signal with a text-to-speech technology. The original synthetic human voice signal is input to a timbre transformation model for transforming the original synthetic human voice signal to a synthetic human voice signal of a specific timbre. The timbre transformation model is established by training it with paired human voice signals (real human voice signals and synthetic human voice signals). Then, the synthetic human voice signal that is transformed is played.

Based on the above, with the timbre-selectable human voice playback system, the method thereof, the user may listen to the selected voice timbre and the synthesized speech signal according to the selected article text anytime and anywhere, instead of listening to unfamiliar and emotionless voice timbre, as long as the real human voice signal of a specific timbre and the corresponding text script are saved or collected, and a text database for selecting an article text for playing is established in advance. In addition, the user may select a voice timbre from past files of synthetic speech and instantly recall the familiar voice timbre.

To make the above features and advantages of the disclosure more comprehensible, several embodiments accompanied with drawings are described in detail as follows

### BRIEF DESCRIPTION OF THE DRAWINGS

The accompanying drawings are included to provide a further understanding of the disclosure, and are incorporated in and constitute a part of this specification. The drawings illustrate exemplary embodiments of the disclosure and, together with the description, serve to explain the principles of the disclosure.

FIG. 1 is a block diagram of components of a human voice playback system according to an embodiment of the disclosure.

FIG. 2 is a flow chart of a human voice playback method according to an embodiment of the disclosure.

FIG. 3 is a flow chart of a human voice playback method with image according to an embodiment of the disclosure.

FIG. 4 is a block diagram of components of a human voice playback system according to another embodiment of the disclosure.

FIG. 5 is a flow chart of a human voice playback method with a mechanical head according to an embodiment of the disclosure.

### DESCRIPTION OF THE EMBODIMENTS

Some other embodiments of the invention are provided as follows. It should be noted that the reference numerals and part of the contents of the previous embodiment are used in the following embodiments, in which identical reference numerals indicate identical or similar components, and repeated description of the same technical contents is omitted. Please refer to the description of the previous embodiment for the omitted contents, which will not be repeated hereinafter.

Hereinafter, a timbre-selectable human voice playback system is referred to as a human voice playback system, and a timbre-selectable human voice playback method is referred to as a human voice playback method.

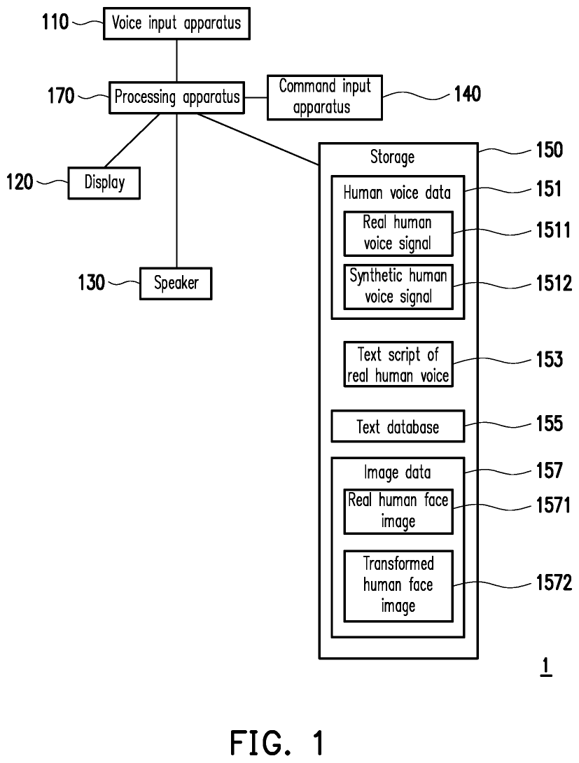

FIG. 1 is a block diagram of components of a human voice playback system 1 according to an embodiment of the disclosure. Referring to FIG. 1, the human voice playback system 1 includes, at least but not limited to, a voice input apparatus 110, a display 120, a speaker 130, a command input apparatus 140, a storage 150 and a processing apparatus 170.

The voice input apparatus 110 may be an omnidirectional microphone, a directional microphone or other reception apparatuses (which may include electronic components, analog-to-digital converters, filters and audio processors) that receive and convert sound waves (such as human voices, ambient sounds and sounds of machine operation) to audio signals, a communication transceiver (that supports the fourth-generation (4G) mobile network, Wi-Fi and other communication standards) or a transmission interface (such as universal serial bus (USB), thunderbolt). In this embodiment, the voice input apparatus 110 may generate a real human voice signal 1511 in response to the receiving of a real human voice wave, and may also directly input a real human voice signal 1511 through an external device (such as a flash drive, a compact disc) or from the Internet.

The display 120 may be a display of various types, such as a liquid crystal display (LCD), a light-emitting diode (LED) display, or an organic light-emitting diode (OLED) display. In an embodiment of the disclosure, the display 120 is adapted to present the user interface, and the details of said user interface is to be described in the following embodiments.

The speaker 130, also called a loudspeaker, is composed of electronic components such as an electromagnet, a coil and a diaphragm, so as to convert a voltage signal to a sound wave.

The command input apparatus 140 may be a touch panel of various types (such as capacitive, resistive, or optical type), a keyboard, or a mouse, which is adapted for receiving the command input by the user (such as touch, press, slide operations). In an embodiment of the disclosure, the command input apparatus 140 is adapted to receive a selection command from the user in response to the content presented by the display 120 on the user interface.

The storage 150 may be a fixed or removable random access memory (RAM), a read-only memory (ROM), a flash memory or similar components of various types, or a storage medium of a combination of the above components. The storage 150 is adapted for storing a software program, a human voice signal 151 (including the real human voice signal 1511 and the synthetic human voice signal 1512), a text script 153 for model training, a text database 155, image data 157 (including a real human face image 1571 and a transformed human face image 1572), acoustic features of a real human voice, acoustic features of a synthetic human voice, a timbre transformation model, and mouth shape-variation data, and other data or files. The details of said software programs, data and files are to be described in the following embodiments.

The processing apparatus 170 is connected to the voice input apparatus 110, the display 120, the speaker 130, the command input apparatus 140 and the storage 150. The processing apparatus 170 may be an apparatus such as a desktop computer, a notebook computer, a server or a workstation (including at least a central unit (CPU)), other programmable microprocessors for general use or special use, digital signal processors (DSP), programmable controllers, application-specific integrated circuits (ASIC), other similar apparatuses or processors combining the foregoing components. In an embodiment of the disclosure, the processing apparatus 170 is adapted to execute all operations of the human voice playback system 1, such as accessing the data or files stored in the storage 150, obtaining and processing the real human voice signal 1511 collected by the voice input apparatus 110, obtaining the command input by the user that are received by the command input apparatus 140, presenting the user interface through the display 120, and playing the synthetic human voice signal 1512 transformed by the timbre transformation model through the speaker 130.

It should be noted that, according to different application requirements, multiple apparatuses in the human voice playback system 1 may be integrated into one device. For example, the voice input apparatus 110, the display 120, the speaker 130 and the command input apparatus 140 may be integrated to form a smart phone, a tablet, a desktop computer or a notebook computer for use by the user; and the storage 150 and the processing apparatus 170 may be a cloud server transmitting and receiving the human voice signal 151 through Internet. Alternatively, all apparatuses in the human voice playback system 1 may be integrated into one device, and the disclosure is not limited thereto.

In order to facilitate better understanding of the operations of the disclosure, various embodiments are to be described below to explain the operations of the human voice playback system 1 of the disclosure. In the following paragraphs, reference will be made to the components and modules of the human voice playback system 1 for describing the method as described in the embodiments of the disclosure. Steps of the method may be adjusted according to the situation of implementation, and the disclosure is not limited thereto.

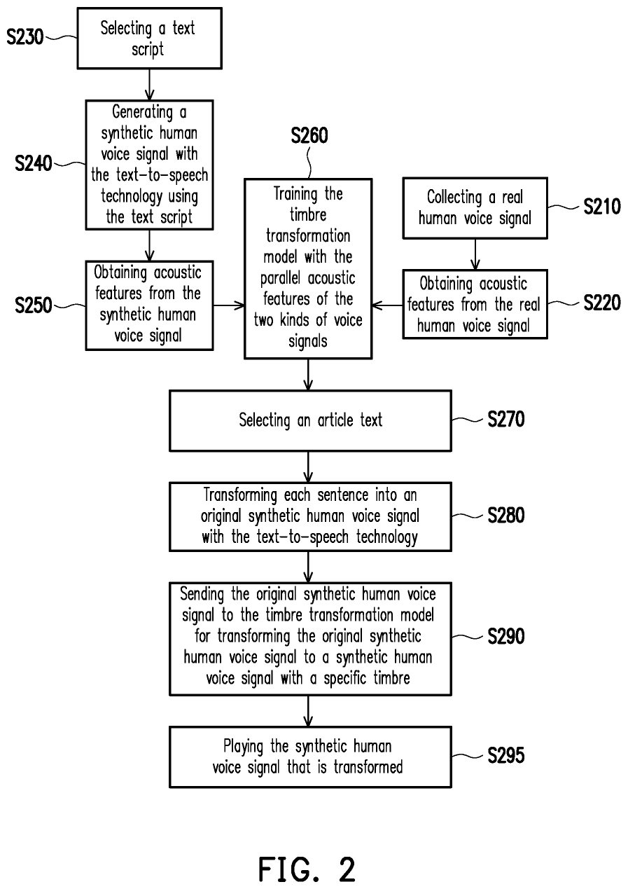

FIG. 2 is a flow chart of a human voice playback method according to an embodiment of the disclosure. Referring to FIG. 2, the processing apparatus 170 collects at least one real human voice signal 1511 (step S210). In an embodiment, the processing apparatus 170 may play an indicating text's corresponding voice signal through, for example, a speaker 130, or may present an indicating text through the display 120 (a display such as an LCD display, a LED display or an OLED display), to guide the user to read a specified text aloud. The processing apparatus 170 may save the voice signal uttered by a person through the voice input apparatus 110. For example, each member of the family reads a paragraph of a story aloud through a microphone to record multiple real human voice signals 1511, and said real human voice signals 1511 may be uploaded to the storage 150 in the cloud server. It should be noted that, the human voice playback system 1 may not provide specific content of the text to be read aloud by the user, as long as the human voice is recorded by the voice input apparatus 110 with a sufficient duration (such as 10 seconds or 30 seconds). In another embodiment, the processing apparatus 170 may obtain the real human voice signal 1511 (which may be extracted from a speech, a conversation, a concert, etc.) from captured network packet, data uploaded by the user, or data stored in an external or internal storage media (such as a flash drive, a disc, and an external hard drive) through the voice input apparatus 110. For example, the user inputs a favorite singer's voice through the user interface, and the voice input apparatus 110 searches on the Internet and obtains a speech or a song of the said singer. In another example, the user interface presents the photo or name of some radio hosts for the elder's selection, and the voice input apparatus 110 records said radio host's voice from the online radio on the Internet. The real human voice signal 1511 may be waveform data of the original sound or compressed/encoded audio files, but the disclosure is not limited thereto.

Next, the processing apparatus 170 obtains acoustic features from the real human voice signal 1511 (step S220). Specifically, based on different languages (such as Chinese, English, French), the processing apparatus 170 may obtain signal segments (possibly through saving with different pitches, lexical tones, etc.) corresponding to each speech unit of the language (such as finals and initials, vowels and consonants) from each real human voice signal 1511. Alternatively, the processing apparatus 170 may also obtain, for example, the features of each real human voice signal 1511 from the spectrum domain, to further obtain the acoustic features required by the timbre transformation model in the following process.

On the other hand, the processing apparatus 170 may select the text script 153 for model training (step S230). The text script 153 for model training may be the same or different from the indicating text in step S210, or may be other text materials designed to facilitate subsequent training of the timbre transformation model (for example, sentences including all finals or vowels), but the disclosure is not limit thereto. For example, the real human voice signal 1511 is an advertisement slogan, and the text script is Chinese Tang poetry. It should be noted that, the text script 153 may be built-in or automatically obtained externally, or may be selected by the user through the user interface on the display 120. Next, the processing apparatus 170 generates a synthetic human voice signal with the text-to-speech technology using the text script 153 for model training (step S240). Specifically, after analyzing the text script 153 selected for model training, such as word segmentation, tone sandhi and symbol pronunciation, the processing apparatus 170 generates prosodic parameters (such as pitch-contour, duration, intensity and pause, etc.) and conducts voice signal synthesis with a signal waveform synthesizer such as the format synthesizer, the sine wave synthesizer, or the hidden Markov models (HMM), to generate a synthetic human voice signal. In other embodiments, the processing apparatus 170 may also directly send the text script 153 for model training to an external or built-in text-to-speech engine (such as that engine developed by Google, Industrial Technology Research Institute of Taiwan, or AT & T Natural Voices) to produce a synthetic human voice signal. Said synthetic human voice signal may be waveform data of the original sound or compressed/encoded audio files, but the disclosure is not limited thereto. It should be noted that, in some embodiments, the synthetic human voice signal may also be data of audio books, audio files, recording files, etc. obtained from the Internet or external storage media, but the present invention is not limited thereto. For example, the voice input apparatus 110 obtains a synthetic human voice signal recorded for audio books or video websites from an online library.

Next, the processing apparatus 170 obtains acoustic features of a synthetic voice from the synthetic human voice signal 1512 (step S250). Specifically, the processing apparatus 170 may, in the same or similar manner as in step S220, obtain signal segments corresponding to each speech unit or may obtain the features of each synthetic human voice signal from the spectrum domain, to further obtain the acoustic features required by the timbre transformation model in the following process. It should be noted that, there are various types of acoustic features for real human voice and synthetic human voice, which may be selected according to actual needs, and the disclosure is not limited thereto.

Then, the processing apparatus 170 may train the timbre transformation model with the acoustic features of the real human voice and the acoustic features of the synthetic human voice (step S260). Specifically, the processing apparatus 170 may take the acoustic features of the real human voice and the acoustic features of the synthetic human voice as training samples, and takes the synthetic human voice signal 1512 as a source sound and the real human voice signal 1511 as a target sound for training models such as the Gaussian Mixture Model (GMM) and the Artificial Neural Network (ANN). The model obtained in the training is used as the timbre transformation model, such that any synthetic human voice signal is transformed into a synthetic human voice signal 1512 with a specific timbre.

It should be noted that, in another embodiment, said timbre transformation model may also be generated by analyzing the differences between the spectrum or timbre of the real human voice signal 1511 and that of the synthetic human voice signal. If so, the content of the text script 153 for model training as used for generating the synthetic human voice signal is similar to or the same as that of the real human voice signal 1511. In principle, the timbre transformation model is established based on the real human voice signal 1511.

After the timbre transformation model is established, the processing apparatus 170 may select an article text from the text database 155 (step S270). Specifically, the processing apparatus 170 may present or sound a selection indication of the article texts through the display 120 or the speaker 130, and the article texts from the text database 155 may be got from mails, messages, books, advertisements, news, and/or other text sources. It should be noted that, depending on the needs, the human voice playback system 1 may obtain the article text by the user input at any time, and may even connect to a specific website to get the article text. Then, the processing apparatus 170 receives the user's command to select an article text through the command input apparatus 140, such as a touch screen, a keyboard or a mouse, and determines the article text based on the inputted command.

For example, the display 120 of a mobile phone presents titles or images of multiple fairy tales. After the user selects a specific fairy tale, the processing apparatus 170 retrieves the corresponding text file (i.e., article text) for the fairy tale from the storage 150 or from the Internet. The display 120 of a computer presents multiple news channels. After the user selects a specific news channel, the processing apparatus 170 instantly saves the speech signal of the news anchor or the reporter in the news channel, recognizes the words spoken (through speech-to-text technology), and put the words into a text file (i.e., an article text). Then, the processing apparatus 170 transforms the sentences in the selected article text into original synthetic human voice signals with the text-to-speech technology (step 280). In this embodiment, the processing apparatus 170 may generate original synthetic human voice signals in the same or similar manner as in step S240 (such as text analysis, generation of prosodic parameters, signal synthesis, text-to-speech engine). Said original synthetic human voice signals may be waveform data or compressed/encoded audio files, but the disclosure is not limited thereto.

The processing apparatus 170 then sends the original synthetic human voice signal to the timbre transformation model trained in step S260 to transform the original synthetic human voice signal to a synthetic human voice signal 1512 of a specific timbre (step S290). Specifically, the processing apparatus 170 may obtain the acoustic features of the original synthetic human voice in a same or similar manner as step S220 and step S250, then perform spectral mapping and/or pitch adjustment to the acoustic features of the original synthetic human voice signal through models such as the GMM and the ANN, and the timbre of the original synthetic human voice signal is changed thereby. Alternatively, the processing apparatus 170 may adjust the original synthetic human voice signal directly based on the differences between the real human voice signal 1511 and the synthetic human voice signal 1512 to simulate the timbre of the real human voice. Then, the processing apparatus 170 may play said synthetic human voice signal 1512 processed with the timbre transformation to the speaker 130 (step S295). Herein, the transformed synthetic human voice signal 1512 has a timbre and a tone similar to the real human voice signal 1511. As such, the user may listen to his/her familiar voice anytime and anywhere, as the person whose voice is desired by the user does not need to save a large number of voice signals.

For example, when the children want a specific person to tell them a story, they can immediately hear a story told with the voice timbre of this specific person. The mother can save her voices before going on a business trip, and the baby can still listen to the story through speaker 130 at any time when the mother is away on a business trip. In addition, after the grandfather passes away, the processing apparatus 170 can establish a timbre transformation model based on films or sound files that had saved during his lifetime, so that the grandson can still listen to stories told in the grandfather's voice timbre through the human voice playback system 1.

To better meet the actual needs, in an embodiment, the processing apparatus 170 may also provide a user interface (for example, through the display 120 or a physical buttons) to present labels for multiple real human voice signals 1511 and article titles in the text database 155 corresponding to different persons. The processing apparatus 170 may receive the commands to select any one of the real human voice signals 1511 and any one of the text articles from the text database 155 on the user interface through the command input apparatus 140. In response to the said commands for selections, the processing apparatus 170 applies the timbre transformation model as trained by the selected real human voice signal 1511 in the foregoing step S270 to step S290 for transforming the selected article text into a synthetic human voice signal 1512 of a specific timbre.

For example, the user selects a radio host that the elder likes, and the processing apparatus 170 establishes a timbre transformation model corresponding to said radio host. In addition, the user interface may present options such as domestic news, foreign news, sports news, entertainment news. After the elder selects the domestic news, the processing apparatus 170 obtains the news text of the domestic news from the Internet and generates a synthetic human voice signal 1512 of a specific timbre of a specific radio host through the timbre transformation model, such that the elder can listen to live news read aloud by his/her favorite radio host. Alternatively, the user can input the idol's name through the user's mobile phone, and the processing apparatus 170 establishes a timbre transformation model corresponding to said idol. When promoting a product, the advertiser inputs the text of the advertisement to the processing apparatus 170, and after a synthetic human voice signal 1512 of the specific idol's timbre is generated through the timbre transformation model corresponding to the idol, the user can hear his/her favorite idol promoting said product.

In addition, as the human voice timbre may change with the growing of age, the user may wish to hear the voice that a person used to have in the past. In an embodiment, after recording the real human voice signal 1511 through the voice input apparatus 110, the processing apparatus 170 annotates the recording time or collection time as well as the identification information of the real person recoding the real human voice signal 1511. As such, the storage 150 may save the real human voice signals 1511 recorded by multiple real persons at multiple recording times. The processing apparatus 170 trains the timbre transformation models based on all the recorded real human voice signals 1511 and the corresponding synthetic human voice signals, respectively. Next, the processing apparatus 170 presents the real persons and the recording times through a user interface, and receives the commands to select the real persons and the recording times on the user interface through the input apparatus. In response to said commands for selections, the processing apparatus 170 decides a timbre transformation model corresponding to the selected real human voice signal 1511, and then transforms the original synthetic human voice signal through the timbre transformation model.

For example, when the user records a speech through the microphone, the processing apparatus 170 annotates the recording timing of each real human voice signal 1511. Alternatively, when obtaining a real human voice signal 1511 of a specific idol from the Internet, the voice input apparatus 110 searches the recording timing of said real human voice signal 1511 or the age of said idol when recording said real human voice signal 1511.

In addition, in an embodiment, when the speaker 130 is playing a synthetic human voice signal 1512 transformed by a timbre transformation model corresponding to a real human voice signal 1511, in response to the user's command to select another real human voice signal 1511, the processing apparatus 170 may instantly select another corresponding timbre transformation model and select an appropriate timing to switch from the transformed human voice signal 1512 currently played to said another timbre transformation model corresponding the real human voice signal 1511 newly selected by the user. As such, the user may instantly hear the voice of another person without the playing of voice signals being interrupted.

For example, when the children want a specific person to tell them a story, they can immediately hear a story told in the voice timbre of this specific person. A story can be designated to be told by the father and the mother in turn, or by the father, mother, grandfather and grandmother in turn, and the turns are selectable instantly. The human voice playback system 1 directly transforms the sentences of the story to the father's or the mother's voice, such that the children feel as if their parent is actually reading the story for them through the human voice playback system 1.

In addition, by updating the real human voice signal 1511 and extending the text database 155, the human voice playback system 1 may better meet the needs of the users. For example, the voice input apparatus 110 may regularly search for saving files of a designated celebrity or news anchor from the Internet. The processing apparatus 170 may regularly download audio books from the online library. The user may purchase e-books from the Internet.

In addition, the disclosure further provides a non-transitory computer readable recording medium (a storage medium such as a hard disk, a disc, a flash memory, a solid state disk (SSD)), said computer readable recording medium may store multiple program code segments (such as program code segments for detecting the storage space, for presenting spatial adjustment options, for maintaining operations, and for presenting images). After said program code segments are loaded to and performed by the processor of the processing apparatus 170, the processes for the above-described timbre-selectable human voice playback method can be fully implemented. In other words, said human voice playback method may be executed with an application program (APP) loaded on a mobile phone, a tablet computer or a personal computer for the user to operate.

For example, an APP on a mobile phone provides a user interface for the user to select a favorite celebrity, and the processing apparatus 170 in the cloud searches for voice recording files or video files with sounds based on the selected celebrity and accordingly establishes a timbre transformation model corresponding to said celebrity. When the user listens to the online radio through the speaker 130 of a mobile phone, the processing apparatus 170 may transform the promotion text provided by the advertiser with the timbre transformation model to generate a synthetic human voice signal of said star's voice timbre. Said synthetic human voice signal may be inserted in the commercial advertising time period for the user to listen to product promotions spoken in the user's favorite star's voice.

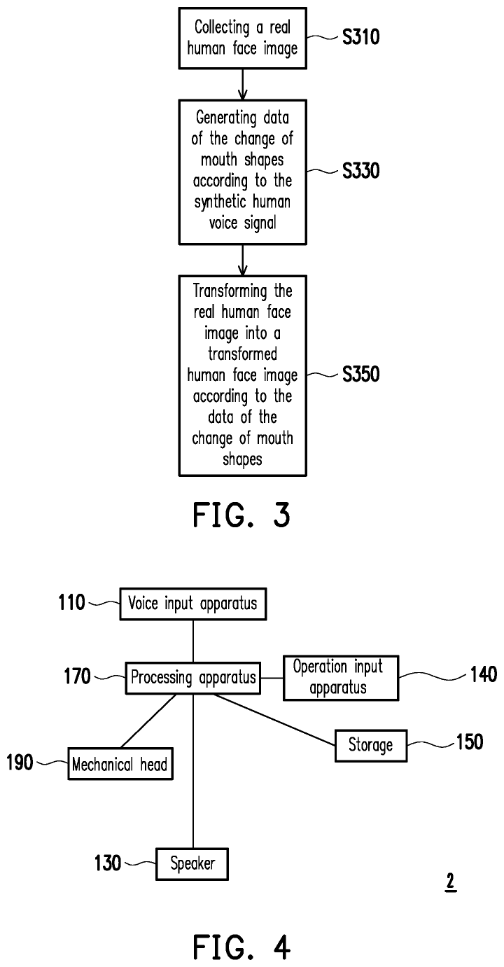

On the other hand, to enhance the authenticity and the reality experience, an embodiment of the disclosure may further be combined with the visual image technology. FIG. 3 is a flow chart of a human voice playback method with image according to an embodiment of the disclosure. Referring to FIG. 3, the processing apparatus 170 collects at least one real human face image 1571 (step S310). In an embodiment, when performing the previous step S210 of recording the real human voice signal 1511, the processing apparatus 170 may simultaneously record a real human face image of the user with an image capturing apparatus (such as a camera and a video recorder). For example, a member of the family reads sentences aloud to the image capture apparatus and the voice input apparatus 110, so that the processing apparatus 170 can obtain the real human voice signal 1511 and the real human face image 1571 at the same time. It should be noted that, the real human voice signal 1511 and the real human face image 1571 may be integrated into a real face video with both sound and image or may be two separate data, the disclosure is not limited thereto. In another embodiment, the processing apparatus 170 may obtain the real human face image 1571 (which may be a video from a video platform, an advertisement clip, a talk show video clip, a movie clip, etc.) from the captured network packet, data uploaded by the user, or data stored in an external or internal storage media (such as a flash drive, a disc, and an external hard drive). For example, the user inputs a favorite actor through the user interface, and the processing apparatus 170 searches on the Internet and obtains a video of said actor in speaking.

After the synthetic human voice signal 1512 of a specific timbre is generated in the foregoing step S290, the processing apparatus 170 generates mouth shape-variation data according to said synthetic human voice signal 1512 (step S330). Specifically, the processing apparatus 170 sequentially generates the mouth shapes (which may include the contour of lips, teeth, tongue or a combination thereof) corresponding to the synthetic human voice signal 1512 in a chronological order with a mouth shape transformation model trained by machine learning, and takes the mouth shapes obtained in a chronological order as the mouth shape-variation data. For example, the processing apparatus 170 establishes a mouth shape transformation model corresponding to different persons according to the real human face image 1571. After the user selects a specific movie star and a specific martial arts novel, the processing apparatus 170 generates mouth shape-variation data of said movie star, and said mouth shape-variation data indicates the mouth movements of said movie star reading said martial arts novel.

Next, the processing apparatus 170 transforms the real human face image 1571 into a transformed human face image 1572 according to the data of the change of mouth shapes (step S350). The processing apparatus 170 changes the mouth area in the real human face image 1571 according to the mouth shapes indicated in the mouth shape-variation data, and the image of the mouth area changes according to the chronological order indicated in the mouth shape-variation data. Finally, the processing apparatus 170 may simultaneously display the transformed human face image 1572 and play the synthetic human voice signal 1512 respectively with the display 120 and the speaker 130 (the transformed human face image 1572 and the synthetic human voice signal 1512 may be integrated into one video or may be two separate data). For example, the user interface presents photos of the father and mother as well as the covers of storybooks. After the children select the mother and the story of Little Red Riding Hood, the display 120 presents the mother who is telling the story, and the speaker 130 plays the voice of the mother telling the story.

In addition, as the robot technology has developed rapidly in recent years, many humanoid robots have appeared on the market. FIG. 4 is a block diagram of components of a human voice playback system 2 according to an embodiment of the disclosure. Referring to FIG. 4, the apparatuses same as those of FIG. 1 are not repeated herein. The difference between the human voice playback system 1 of FIG. 1 and the human voice playback system 2 is that, the human voice playback system 2 further includes a mechanical head 190. The facial expressions of this mechanical head 190 may be controlled by the processing apparatus 170. For example, the processing apparatus 170 may control the mechanical head 190 to present facial expressions such as smiling, speaking and opening the mouth.

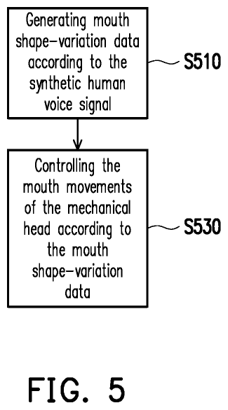

FIG. 5 is a flow chart of a human voice playback method including the control of the mechanical head 190 according to an embodiment of the disclosure. Referring to FIG. 5, after the synthetic human voice signal 1512 of a specific timbre is generated in the foregoing step S290, the processing apparatus 170 generates mouth shape-variation data according to said synthetic human voice signal 1512 (step S510). Details of this step have been described in step S330 and are not repeated herein. Next, the processing apparatus 170 controls the mouth movements of the mechanical head 190 according to said mouth shape-variation data and simultaneously plays the synthetic human voice signal 1512 to the speaker 130 (step S530). The processing apparatus 170 adjusts the mechanical components of the mouth on the mechanical head 190 according to the mouth shapes indicated in the mouth shape-variation data, and such that the mechanical components of the mouth operate according to the chronological order indicated in the mouth shape-variation data. For example, after a teenager selects an idol and a love story, the mechanical head 190 simulates the speaking of said idol, and the speaker 130 plays the voice of said idol reading a love story at the same time.

In summary, the human voice playback system, the human voice playback method thereof of an embodiment of the disclosure transform a selected article text to an original synthetic human voice signal with the text-to-speech technology, and then transform said original synthetic human voice signal to a synthetic human voice signal of a specific target person's voice timbre through a timbre transformation model trained with the collected real human voice signals and the corresponding synthetic human voice signals. As such, the user may listen to the text article told by a preferred voice timbre whenever the user likes. In addition, an embodiment of the disclosure may also combine the synthetic human voice signal with a transformed human face image or a mechanical head for improving the user experience.

It will be apparent to those skilled in the art that various modifications and variations can be made to the disclosed embodiments without departing from the scope or spirit of the disclosure. In view of the foregoing, it is intended that the disclosure covers modifications and variations of this disclosure provided that they fall within the scope of the following claims and their equivalents.

What is claimed is:

1. A human voice playback system, comprising:
a speaker, playing a sound;
a storage, saving a text database; and
a processing apparatus, connected to the speaker and the storage, the processing apparatus obtains at least one real human voice signal, transforms a text from the text database to an original synthetic human voice signal with a text-to-speech technology, and inputs the original synthetic human voice signal to a timbre transformation model for transforming the original synthetic human voice signal to a synthetic human voice signal, wherein the timbre transformation model is trained with the at least one real human voice signal, and the processing apparatus plays the synthetic human voice signal with the speaker.

2. The human voice playback system according to claim 1, wherein the processing apparatus obtains at least one first acoustic feature from the at least one real human voice signal, generates the synthetic human voice signal with the text-to-speech technology according to a text script corresponding to the at least one real human voice signal, obtains at least one second acoustic feature from the synthetic human voice signal, and trains the timbre transformation model with the at least one first acoustic feature and the at least one second acoustic feature.

3. The human voice playback system according to claim 1, wherein the processing apparatus provides a user interface, the user interface presents the at least one real human voice signal and a plurality of texts saved in the text database and receives a selection command to select one of the at least one real human voice signal and one of the plurality of texts saved in the text database, and the processing apparatus transforms a sentence in a selected text to the synthetic human voice signal in response to the selection command.

4. The human voice playback system according to claim 1, wherein the storage further saves the at least one real human voice signal recorded by a plurality of real persons at a plurality of recording times, the processing apparatus provides a user interface presenting the plurality of real persons and the plurality of recording times, receives a selection command to select one of the plurality of real persons and one of the plurality of recording times on the user interface, and obtains the timbre transformation model corresponding to a selected real human voice signal in response to the selection command.

5. The human voice playback system according to claim 1, wherein a content of the text saved in the text database relates to at least one of text sources, mails, messages, books, advertisements and news.

6. The human voice playback system according to claim 1, further comprising:
a display, connected to the processing apparatus, wherein
the processing apparatus collects at least one real human face image, generating a mouth shape-variation data according to the synthetic human voice signal, transforms one of the at least one real human face image into a transformed human face image according to the mouth shape-variation data, and displays the transformed human face image with the display and simultaneously plays the synthetic human voice signal with the speaker.

7. The human voice playback system according to claim 1, further comprising:
a mechanical head, connected to the processing apparatus, wherein
the processing apparatus generates a mouth shape-variation data according to the synthetic human voice signal, controls a mouth movements of the mechanical head according to the mouth shape-variation data and simultaneously plays the synthetic human voice signal with the speaker.

8. A human voice playback method, comprising:
collecting at least one real human voice signal,
transforming a text to an original synthetic human voice signal with a text-to-speech technology;
inputting the original synthetic human voice signal to a timbre transformation model for transforming the original synthetic human voice signal to a synthetic human voice signal, wherein the timbre transformation model is trained with the at least one real human voice signal; and
playing the synthetic human voice signal that is transformed.

9. The human voice playback method according to claim 8, wherein before the step of inputting the original synthetic human voice signal to the timbre transformation model for transforming the original synthetic human voice signal to the synthetic human voice signal, the human voice playback method further comprises:
analyzing at least one first acoustic feature from the at least one real human voice signal;
generating a synthetic human voice signal with the text-to-speech technology according to a text script corresponding to the at least one real human voice signal;
analyzing at least one second acoustic feature from the synthetic human voice signal; and
training the timbre transformation model with the at least one first acoustic feature and the at least one second acoustic feature.

10. The human voice playback method according to claim 8, wherein before the step of inputting the original synthetic human voice signal to the timbre transformation model for transforming the original synthetic human voice signal to the synthetic human voice signal, the human voice playback method further comprises:
providing a user interface, wherein the user interface presents the at least one real human voice signal as collected and a plurality of texts saved in a text database;
receiving a selection command to select one of the at least one real human voice signal and one of the plurality of texts saved in the text database on the user interface; and
transforming a sentence in a selected text to the synthetic human voice signal in response to the selection command.

11. The human voice playback method according to claim 8, wherein the step of obtaining the plurality of real human voice data comprises:
saving a real human voice signal saved by a plurality of real persons at a plurality of recording times;
providing a user interface presenting the plurality of real persons and the plurality of recording times;
receiving a selection command to select one of the plurality of real persons and one of the plurality of recording times on the user interface; and,
training the timbre transformation model corresponding to a selected real human voice signal in response to the selection operation.

12. The human voice playback method according to claim 8, wherein a content of the text relates to at least one of text sources, mails, messages, books, advertisements and news.

13. The human voice playback method according to claim 8, wherein after the step of transforming to the synthetic human voice signal, the human voice playback method further comprises:
obtaining a real human face image;
generating a mouth shape-variation data according to the synthetic human voice signal;
transforming the real human face image into a transformed human face image according to the mouth shape-variation data; and
simultaneously displaying the transformed human face image while playing the synthetic human voice signal.

14. The human voice playback method according to claim 8, where after the step of transforming to the synthetic human voice signal, the human voice playback method further comprises:
generating a mouth shape-variation data according to the synthetic human voice signal;
controlling a mouth movements of the mechanical head according to the mouth shape-variation data, and simultaneously playing the synthetic human voice signal.

15. A non-transitory computer readable recording medium, saving a program code loaded by a processor of an apparatus for performing the following:
collecting at least one real human voice signal;
transforming a text to an original synthetic human voice signal with a text-to-speech technology;
inputting the original synthetic human voice signal to a timbre transformation model for transforming the original synthetic human voice signal to a synthetic human voice signal, wherein the timbre transformation model is trained with the at least one real human voice signal; and
playing the synthetic human voice signal that is transformed.
